(19) United States
(12) Patent Application Publication
(10) Pub. No.: US 2005/0109001 A1
(43) Pub. Date: May 26, 2005

(54) Transverse conveying auger for a harvesting head

(75) Inventors: Norbert Wolters, Gescher (DE); Clemens Rickert, Stadtlohn (DE)

Correspondence Address: DEERE & COMPANY, One John Deere Place, Moline, IL, 61265-8098, US

(73) Assignee: Deere & Company, a Delaware corporation

(21) Appl. No.: 10/978,036

(22) Filed: Oct. 29, 2004

(30) Foreign Application Priority Data
Nov. 25, 2003 (DE) DE 103 54 977.3

(51) Int. Cl. A01D 61/00

(52) U.S. Cl. 56/16.4 R

(57) ABSTRACT

A transverse conveying auger includes a tubular body and spiral-shaped flutes provided around the body. The flutes extend from the respective outer ends of the body to the center of the body. At the center of the tubular body, a center end disk is provided, to which the respective flutes are connected.

### FIELD OF THE INVENTION

The present invention is directed to a transverse conveying auger for a harvesting head for agricultural crops. The auger has a tubular body and spiral-shaped flutes extending from the outer ends of the body toward the center. A center end disk is approximately perpendicular to the longitudinal axis of the body.

### BACKGROUND OF THE INVENTION

When harvesting plants with agricultural harvesting machines, it is common practice to initially pick the crop to be harvested from the ground (for example, with the tines of a pick-up) or to cut the crop (e.g., by means of the cutter bar of a cutting attachment or mowing and intake devices of a corn picker or mowing and picking or plucking devices of a corn picker or plucker). The plants or crops separated therefrom, e.g., corn ears, are then conveyed in transversely converging fashion and sent to the intake channel or inclined conveyor of the harvesting machine. The lateral conveyance is realized with a transverse conveying auger in many harvesting heads.

A transverse conveying auger of this type is described in DE 38 04 598 A. This auger consists of a tube in the form of a circular cylinder with spiral-shaped flutes arranged around its circumference that serve to convey the harvested crop. The spiral-shaped flutes end and merge in the central region of the transverse conveying auger that lies in front of the intake channel of the forage harvester. Annular end disks are arranged adjacent to the flutes. Radially projecting conveyor plates that extend axially and serve to convey the harvested crop rearward are located between the end disks. In another transverse conveying auger (EP 0 861 583 A), the spiral-shaped flutes of the auger extend as far as the center and end at this location at an edge that extends approximately radially.

Transverse conveying augers have the function of delivering the harvested crop as uniformly as possible over the width of the intake channel such that the crop reaches the operating elements of the harvesting machine equally uniformly relative to its width. This uniformity is important, for example, in conventional combine-harvesters with straw shakers because shakers subjected to a relatively high load produce more significant losses than shakers that are subjected to lesser loads. The uniform delivery over the width of the machine is also important in bailers because homogenous bales can be obtained only in this way.

Transverse conveying augers with end disks and conveying plates arranged therebetween deliver most of the crop received from the flutes rearward at the end disks, wherein the conveying plates essentially merely serve to convey the crop introduced over their width rearwards. The intake channel of the harvesting machine consequently is subjected to higher loads on the outside in many instances. In transverse conveying augers with continuous flutes, the major portion of the harvested crop is delivered in the central region such that the crop distribution is also not homogenous in this case. If plants are placed or wound around the terminal edge of the flutes, an undesirable crop back-up may occur, for example, in corn pickers that are operated in a mode in which a significant quantity of plant material is taken in addition to the corn ears.

### SUMMARY OF THE INVENTION

A transverse conveying auger has a tubular body and spiral flutes wound around the body. At least one spiral flute extends from each respective end of the body toward its center, where a single end disk is arranged at least approximately perpendicular to the longitudinal axis of the tubular body. Thus, the end disk is centrally located in front of the intake channel of the harvesting machine.

The center end disk prevents the crop from accumulating in the center of the intake channel of the harvesting machine, since the harvested crop is delivered separately on the left and right sides of the intake channel. The harvested crop accumulates on either side of the central end disk such that significant portions of the harvested crop are delivered to the intake channel of the harvesting machine a certain distance from the end disk. This makes the delivery of the crop to the harvesting machine uniform. In addition, the end disk prevents the crop from becoming attached to the ends of the flutes.

The end disk is preferably annular, although its circumference could be another shape. For example, it could constructed smaller or larger in the direction of rotation or in a wave-like fashion from the transition point to the flutes.

The inwardly converging spiral flutes may be connected respectively at the end disk. Alternatively, the flutes may end a predetermined distance from the end disk, in particular, along an edge that extends radially relative to the tubular body or that becomes continuously flatter. If the flutes end at a distance from the end disk, a region in the center of the body between the flute endss and the center end disk will be free of flutes. Alternatively, axially extending regions of the flutes could be provided at this location or the flutes could transition into axially extending intermediate plates. These regions preferably extend radially relative to the body.

The transverse conveying auger according to the invention is suitable for all harvesting heads and harvesting machines, in which the harvested crop is conveyed in converging fashion, for example, pick-ups for bailers, forage harvesters and forage boxes, cutting attachments and corn pluckers for combine-harvesters and corn pickers for forage harvesters.

### BRIEF DESCRIPTION OF THE DRAWINGS

FIG. 1 is a perspective view of a transverse conveying auger according to a first embodiment of the invention;

FIG. 2 is a perspective view a corn plucker equipped with the transverse conveying auger of FIG. 1; and

FIG. 3 is a perspective view of a transverse conveying auger according to a second embodiment.

### DESCRIPTION OF THE PREFERRED EMBODIMENT

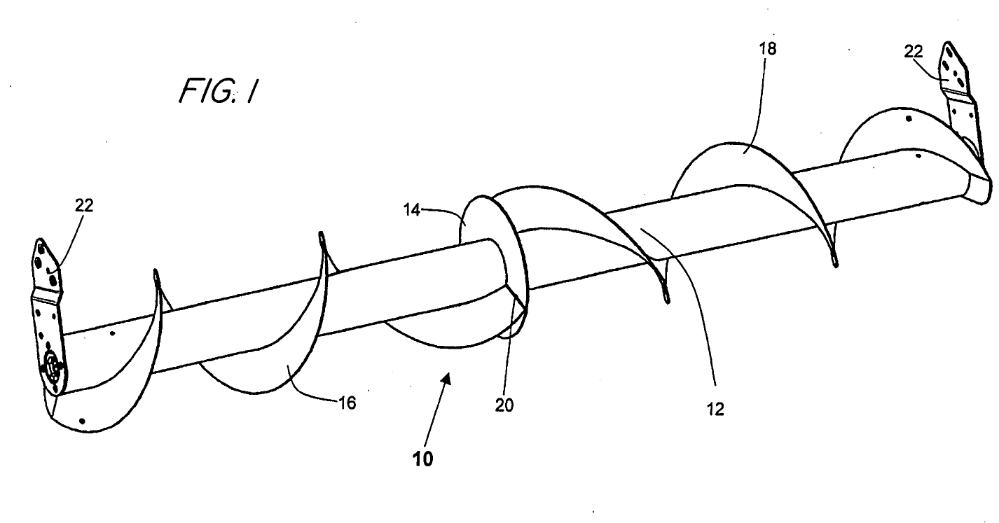

The transverse conveying auger 10 shown in FIG. 1 includes a tubular body 12 in the form of a circular cylinder, a centrally arranged annular end disk 14 that extends orthogonally relative to the longitudinal axis of the body 12 and two spiral-shaped flutes 16,18. Each of the flutes 16,18 extends helically from one outer end of the transverse conveying auger 10 to the end disk 14 arranged in the center of the body 12. Each of the flutes 16,18 is connected to the end disk 14 at an edge 20 that extends radially relative to the body 12 and is fixed at this location by means of a continuous weld. The outside diameter of the flutes 16 is constant over the length of the body 12 and corresponds to the outside diameter of the end disk 14. Brackets 22 for mounting the transverse conveying auger 10 on the frame of a harvesting head are provided on the ends of the body 12.

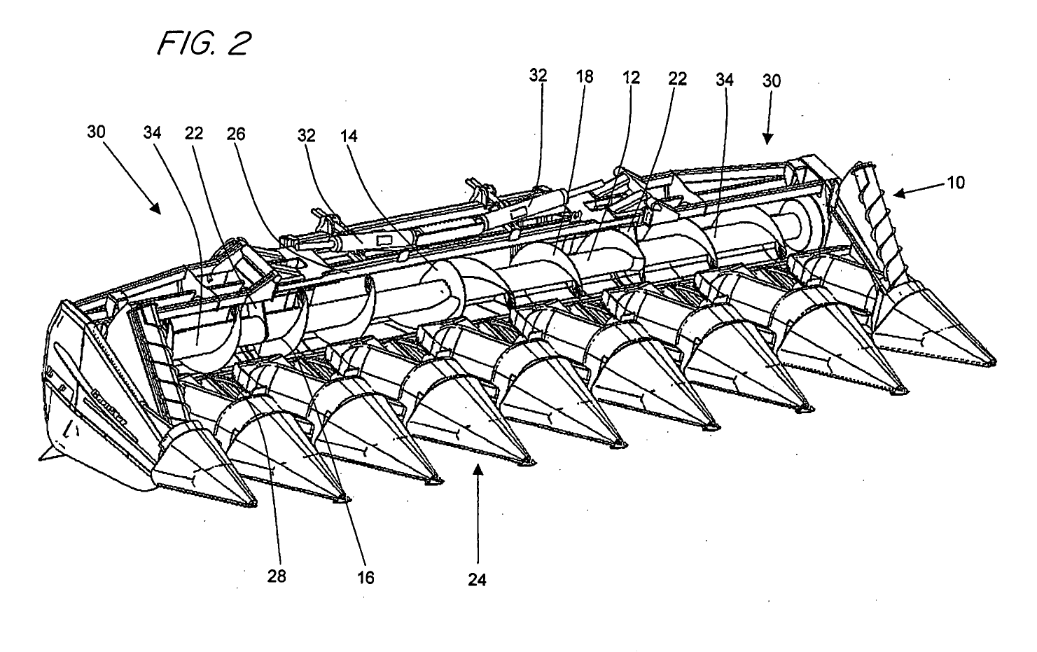

FIG. 2 shows a harvesting head 24 in the form of a corn plucker with a transverse conveying auger 10 according to the invention. The harvesting head 24 contains a frame 26 with eight intake and plucking devices 28 distributed over its front side. In the harvesting mode, the intake and picking devices 28 separate the crop (corn ears) from the plants, the stalks of which are chopped and deposited over the field. The corn ears are entrained by the rotating transverse conveying auger 10 about its longitudinal axis and conveyed to the center of the harvesting head 24, on the rear side of which the inclined conveyor of a combine-harvester is arranged. Lateral parts 30 provided on either side of the harvesting head 24 can be pivoted upwards for transport purposes by means of hydraulic cylinders 32. The lateral parts 30 contain sections 34 of the transverse conveying auger that are torque-coupled with the transverse conveying auger 12 in the operating position shown.

The transverse conveying auger 10 according to the invention contains a central end disk 14 to which flutes 16,18 are connected on either side. This design of the transverse conveying auger prevents the major portion of the harvested crop from being delivered to the center of the inclined conveyor. A significant portion is further delivered to the left and right of the center relative to the forward driving direction of the harvesting head 24, such that the harvested crop is introduced more uniformly into the combine-harvester. The end disk 14 also prevents plants from becoming wound around the ends of the flutes 16,18.

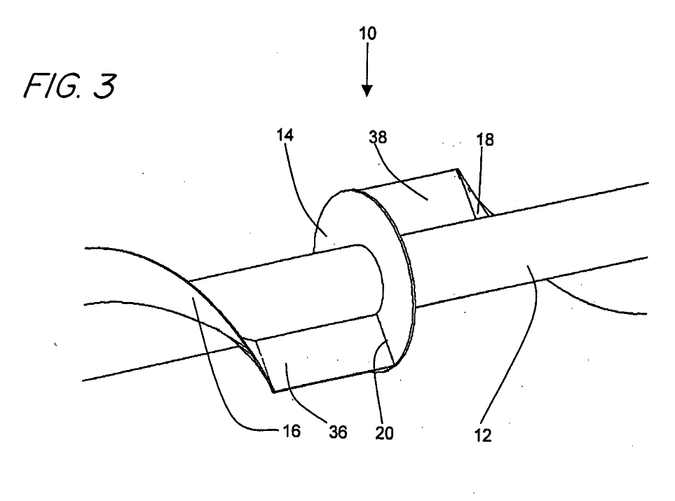

FIG. 3 shows a second embodiment of a transverse conveying auger 10 according to the invention that can also be utilized in the harvesting head 24 according to FIG. 2. Elements that correspond to the first embodiment are designated by the same reference symbols. The transverse conveying auger 10 according to FIG. 3 differs essentially from the embodiment according to FIG. 1 in that the flutes 16,18 terminate a certain distance from the end disk 14 and transition into regions 36,38 that extend axially and radially relative to the body 12. These regions 36,38 reduce the movement of the harvested crop toward the center of the machine and promote its rearward movement into the harvesting machine. However, the regions 36,38 could also be realized in the form of flutes that have a more significant pitch and/or a smaller height in relation to the body 12 than do the outer flutes 16,18.

Having described the preferred embodiment, it will become apparent that various modifications can be made without departing from the scope of the invention as defined in the accompanying claims.

1. A transverse conveying auger for a harvesting head comprising a tubular body having spiral-shaped flutes arranged around said body, each flute respectively extending from an outer side of the tubular body toward the center of the body, and an end disk arranged respectively downstream of the flutes and extending perpendicular to the longitudinal axis of the body wherein only one end disk is arranged in the center of the body.

2. The transverse conveying auger according to claim 1 wherein the end disk is centrally situated in front of an intake channel of a harvesting machine.

3. The transverse conveying auger according to claim 1 wherein the flutes are respectively connected to the end disk along an edge that extends approximately radially relative to the body.

4. The transverse conveying auger according to claim 1 wherein the flutes have ends that are positioned adjacent to the center of the transverse conveying auger and transition into regions that extend axially relative to the tubular body.

5. The transverse conveying auger according to claim 1 wherein the outside diameter of the flutes corresponds to at least approximately the outside diameter of the end disk.

6. The transverse conveying auger according to claim 1 wherein the harvesting head is a corn plucker.

7. The transverse conveying auger according to claim 1 wherein the harvesting head is a corn picker.

8. The transverse conveying auger according to claim 1 wherein the harvesting head includes a cutting attachment.

9. The transverse conveying auger according to claim 1 wherein the harvesting head includes a pick-up mechanism.
